(19) United States
(12) Patent Application Publication
(10) Pub. No.: US 2026/0187777 A1
(43) Pub. Date: Jul. 2, 2026

(54) COMPOSITE MATERIAL MODELING METHOD, SYSTEM, DEVICE, AND MEDIUM

(71) Applicant: Nanchang Hangkong University, Nanchang (CN)

(72) Inventors: Xuefeng Teng, Nanchang (CN); Enci Yuan, Nanchang (CN); Xiao'an Hu, Nanchang (CN); Tianxiao Sui, Nanchang (CN); Qinzheng Yang, Nanchang (CN)

(21) Appl. No.: 19/393,638

(22) Filed: Nov. 19, 2025

(30) Foreign Application Priority Data
Dec. 27, 2024 (CN) 2024119425079

(51) Int. Cl. G06T 7/00; G06T 7/13; G06T 11/00; G06T 17/20; G06V 10/44; G06V 20/64

(52) U.S. Cl. CPC G06T 7/0004; G06T 7/13; G06T 12/30; G06T 17/20; G06V 10/443; G06V 20/64; G06T 2207/30164

(57) ABSTRACT

A composite material modeling method, a system, a device and a medium are provided. The method includes: filtering, based on grayscale values of the CT slice image, pixels corresponding to defect features; determining computational units in the CT slice image, and using a ratio of a number of pixels corresponding to the defect features in a computational unit to a number of pixels in the computational unit as a corresponding element value of a defect parameter matrix to obtain the defect proportion parameter matrix; establishing a finite element model, and obtaining grid units of the finite element model with a same size as a size represented by elements of the defect proportion parameter matrix; and transferring the element values of the defect proportion parameter matrix to the grid units of the finite element model of the composite material, and obtaining a three-dimensional reconstructed model of the composite material.

### CROSS-REFERENCE TO RELATED APPLICATION

This application claims priority to Chinese Patent Application No. 202411942507.9, filed Dec. 27, 2024, which is herein incorporated by reference in its entirety.

### TECHNICAL FIELD

The disclosure relates to the field of three-dimensional modeling technology, and more particularly to a composite material modeling method, a system, a device, and a medium.

### BACKGROUND

A composite material, known for its high specific strength, high specific modulus, and corrosion resistance, holds broad application prospects. Due to the complexity of a real composite material structure, and limitations in the manufacturing process, the materials cannot be completely uniformly dense, and internal defects become an important factor affecting the performance of the composite material. Moreover, the varying weaving methods of different materials result in diverse defect distributions, making it difficult to represent the true internal structure and its effects on macroscopic mechanical properties when establishing numerical simulation models.

In the related art, the simulation modeling of the composite material mainly includes a macroscopic method that regards the composite material as a continuous homogeneous body and a mesoscopic cell method that reflects the weaving structure of the material. The macroscopic method, based on the assumption of continuous uniformity, treats the material as a continuum and introduces damage variables to describe the mechanical behavior of the composite material, failing to consider the non-uniform distribution of internal defects. Although the mesoscopic cell method can characterize the weaving structure of the composite material, the mesoscopic cell method involves a large number of grids, making calculations difficult and impractical for representing the entire component, thus unsuitable for real engineering applications.

In summary, the existing composite material modeling methods, when used for finite element simulation, involve a large number of grids, are difficult to calculate, and fail to accurately represent the entire component, leading to poor accuracy in composite material modeling.

### SUMMARY

In response to the issues existing in the aforementioned field, the disclosure proposes a composite material modeling method, a system, a device, and a medium. By determining the computational units in the CT slice image and using the ratio of the number of pixels corresponding to defect features in a computational unit to the number of pixels in the computational unit as an element value of the defect parameter matrix, the defect proportion parameter matrix is obtained. Based on the number of computational units in the CT slice image, grid division is performed on the finite element model of the composite material. A finite element model that has the same defect distribution features as the actual composite material can be established, thereby enhancing the accuracy of finite element simulation.

In order to address the above technical problems, the disclosure provides a composite material modeling method, including the following steps:
acquiring a computed tomography (CT) slice image of a composite material;
filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
transferring the all element values of the defect proportion parameter matrix to the grid units of the finite element model of the composite material, respectively, and obtaining a three-dimensional reconstructed model of the composite material.

In an embodiment, the composite material modeling method further includes: obtaining, based on the three-dimensional reconstructed model of the composite material, defect distribution of the composite material, positioning, based on the defect distribution, a defect to be repaired in the composite material to obtain a positioning result, generating, based on the positioning result, a movement trajectory of a robot, and controlling, based on the movement trajectory, the robot to repair the defect to be repaired in the composite material.

In an embodiment, the composite material modeling method further includes: determining, based on the three-dimensional reconstructed model of the composite material, whether the composite materials are qualified in terms of residual strength and fatigue life prediction to replace traditional slice sampling.

In an embodiment, the filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix includes:
acquiring grayscale values of pixels of a boundary of the composite material, defects and boundaries of the defects (i.e., grayscale values of composite material boundary pixels, grayscale values of defect pixels, and grayscale values of defect boundary pixels) in the CT slice image;
drawing pixel grayscale contour lines through a first function to obtain a defect feature distribution map of the composite material;
comparing the defect feature distribution map with the CT slice image of the composite material to obtain a comparison result, and adjusting, based on the comparison result, parameters of a second function;
using the grayscale values of pixels in the CT slice image as a quantification reference to traverse grayscale pixels in the composite material region, and to obtain preset-sized pixel regions as the computational units;
obtaining a grayscale threshold to distinguish the defects, determining a number of pixels with a grayscale less than the grayscale threshold in each of pixel arrays (i.e., the preset-sized pixel regions), and determining a ratio of a number of grayscale pixels representing microscopic defects of the composite material in a corresponding one of the computational units to the number of the pixels in the corresponding one of the computational units; and
calculating proportion parameters of the pixel arrays in the CT slice image to output the defect proportion parameter matrix, where each of the pixel arrays represents an output element and includes a defect pixel proportion parameter.

In an embodiment, the establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix includes:
determining, according to the defect proportion parameter matrix, an order of the defect proportion parameter matrix, and setting a grid density of the finite element model; and
obtaining the finite element model of the composite material with a same size as the size represented by the elements of the defect proportion parameter matrix, when the grid number of the finite element model is consistent with the number of the computational units in the composite material region of the CT slice image.

In an embodiment, the obtaining a three-dimensional reconstructed model of the composite material includes:
acquiring target defect parameter coordinates and defect parameter values;
dividing the defect parameter values into intervals;
filtering grid unit serial numbers of the finite element model corresponding to defect parameter coordinates in each of the intervals;
replacing keywords of the grid unit serial numbers in a finite element model file to establish a grid unit set of the finite element model corresponding to each of the intervals and thereby obtain grid unit sets of the finite element model;
using performance parameters of a defect-free composite material as a benchmark, weakening the benchmark according to the intervals of the defect parameter values to obtain weakened benchmarks, and assigning the weakened benchmarks to the grid unit sets of the finite element model respectively, where for each of the grid unit set of the finite element model, material parameter=benchmark×interval upper limit; and
setting, according to the material parameter of each of the grid unit sets, different material properties and cross-sectional properties for the grid unit sets of the finite element model in a finite element software interface to obtain the three-dimensional reconstructed model of the composite material based on the microscopic defects.

In an embodiment, the acquiring target defect parameter coordinates and defect parameter values includes: traversing the defect proportion parameter matrix to find non-zero and non-one defect parameters and coordinates, and outputting the target defect parameter coordinates and the defect parameter values through a third function.

In an embodiment, the dividing the defect parameter values into intervals includes: evenly dividing, according to magnitudes, the defect parameter values into 10 intervals: 0-0.1, 0.1-0.2, . . . , 0.9-1.

In an embodiment, the finite element model is established based on an Abaqus/computer aided engineering (CAE) finite element software.

In an embodiment, the disclosure further provides a composite material modeling system, including: a CT slice image acquisition module, a defect parameter determination module, a finite element model construction module, and a three-dimensional model reconstruction module.

The CT slice image acquisition module is configured to acquire a CT slice image of a composite material.

The defect parameter determination module is configured to filter, based on grayscale values of the CT slice image, pixels corresponding to defect features from the CT slice image; determine computational units in the CT slice image, and use a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix.

The finite element model construction module is configured to establish a finite element model of the composite material; and perform, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix.

The three-dimensional model reconstruction module, is configured to transfer the all element values of the defect proportion parameter matrix to the grid units of the finite element model of the composite material respectively, and obtain a three-dimensional reconstructed model of the composite material.

In an embodiment, the disclosure further provides a computer device, including a memory and a processor. The memory stores a computer program, and the computer program is configured to, when executed by the processor, implement the following steps:
acquiring a CT slice image of a composite material;
filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
transferring the all element values of the defect proportion parameter matrix to the grid units of the finite element model of the composite material, respectively, and obtaining a three-dimensional reconstructed model of the composite material.

In an embodiment, the disclosure further provides a non-transitory computer-readable storage medium. The non-transitory computer-readable storage medium is stored with a computer program, and the computer program is configured to, when executed by a processor, implement the following steps:
acquiring a CT slice image of a composite material;
filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
transferring the all element values of the defect proportion parameter matrix to the grid units of the finite element model of the composite material, respectively, and obtaining a three-dimensional reconstructed model of the composite material.

In an embodiment, each of the CT slice image acquisition module, the defect parameter determination module, the finite element model construction module, and the three-dimensional model reconstruction module is embodied by at least one processor and at least one memory coupled to the at least one processor, and the at least one memory stores computer programs executable by the at least one processor. The finite element model and the three-dimensional reconstructed model are respectively derived from the finite element model construction module and the three-dimensional model reconstruction module.

Compared to the related art, the disclosure has the following beneficial effects.

The composite material modeling method proposed in the disclosure involves acquiring the CT slice image of the composite material and importing the CT slice image into a recognition program to identify and filter out the grayscale pixels corresponding to the defect features. By using image pixel regions of a certain size as the computational units and determining the ratio of a number of defect pixels in a corresponding computational unit to the total number of pixels in the corresponding computational unit as a corresponding element value of the defect parameter matrix to thereby obtain all element values of the defect parameter matrix, the CT slice image can clearly display the defect features of the composite material. The finite element model of the composite material is established, and the grid division is performed on the finite element model according to the size of the pixel arrays processed from the CT image, ensuring that the finite element grid size is same as the size represented by the elements of the defect parameter matrix. The element values of the defect proportion parameter matrix are transferred to the grid units of the finite element model respectively to obtain the three-dimensional reconstructed model of the composite material. The proposed method for modeling the composite material based on microscopic defects allows for establishing the finite element model that has the same defect distribution features as the actual composite material, thereby enhancing the accuracy of finite element simulation. Additionally, the reconstructed model has fewer grid units and higher computational efficiency.

### BRIEF DESCRIPTION OF DRAWINGS

FIG. 1 illustrates a flowchart diagram of a composite material modeling method of the disclosure.

FIG. 2 illustrates a high-resolution CT slice image of the composite material modeling method based on microscopic defects according to an embodiment of the disclosure.

FIG. 3 illustrates a preprocessed CT slice image of the composite material modeling method based on the microscopic defects according to the embodiment of the disclosure.

FIG. 4 illustrates a defect feature recognition image of the composite material modeling method based on the microscopic defects according to the embodiment of the disclosure.

FIG. 5 illustrates a geometric model of the composite material of the composite material modeling method based on the microscopic defects according to the embodiment of the disclosure.

FIG. 6 illustrates a finite element model of the composite material of the composite material modeling method based on the microscopic defects according to the embodiment of the disclosure.

FIG. 7 illustrates a calculation process of different Elset material parameters of the composite material modeling method based on the microscopic defects according to the embodiment of the disclosure.

### DETAILED DESCRIPTION OF EMBODIMENTS

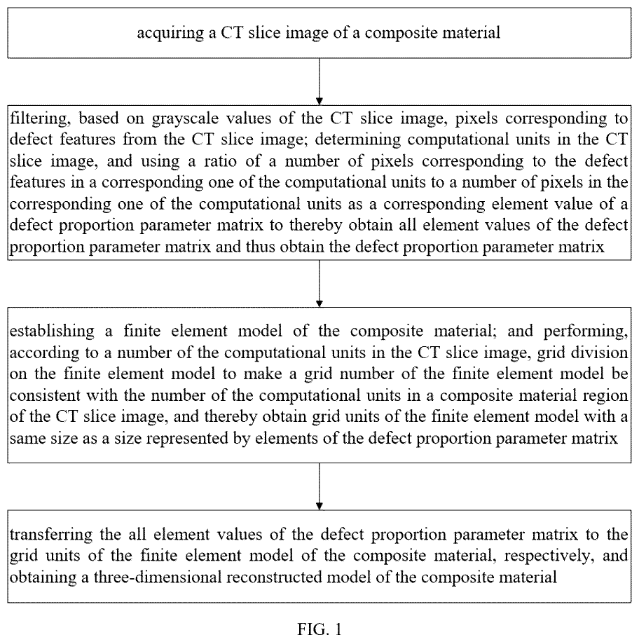

The technical solutions in the embodiments of the disclosure will be clearly and completely described below in conjunction with FIGS. 1-7. It should be understood that the terms used in the disclosure are only for describing specific embodiments and are not intended to limit the disclosure.

As shown in FIG. 1, the disclosure proposes a composite material modeling method, including the following steps:
acquiring a CT slice image of a composite material;
filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
transferring the all element values of the defect proportion parameter matrix to the grid units of the finite element model of the composite material, respectively, and obtaining a three-dimensional reconstructed model of the composite material.

Specifically, the filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix specifically includes:
acquiring grayscale values of pixels of a boundary of the composite material, defects and boundaries of the defects in the CT slice image;
drawing pixel grayscale contour lines through a first function to obtain a defect feature distribution map of the composite material;
comparing the defect feature distribution map with the CT slice image of the composite material to obtain a comparison result, and adjusting, based on the comparison result, parameters of a second function;
using the grayscale values of pixels in the CT slice image as a quantification reference to traverse grayscale pixels in the composite material region, and to obtain preset-sized pixel regions as the computational units;
obtaining a grayscale threshold to distinguish the defects, determining a number of pixels with a grayscale less than the grayscale threshold in each of pixel arrays being the preset-sized pixel regions, and determining a ratio of a number of grayscale pixels representing microscopic defects of the composite material in a corresponding one of the computational units to the number of the pixels in the corresponding one of the computational units; and
calculating proportion parameters of the pixel arrays in the CT slice image to output the defect proportion parameter matrix, where each of the pixel arrays represents an output element and includes a defect pixel proportion parameter.

The establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix includes:
determining, according to the defect proportion parameter matrix, an order of the defect proportion parameter matrix, and setting a grid density of the finite element model; and
obtaining the finite element model of the composite material with a same size as the size represented by the elements of the defect proportion parameter matrix, when the grid number of the finite element model is consistent with the number of the computational units in the composite material region of the CT slice image.

The obtaining a three-dimensional reconstructed model of the composite material includes:
acquiring target defect parameter coordinates and defect parameter values;
dividing the defect parameter values into intervals;
filtering grid unit serial numbers of the finite element model corresponding to defect parameter coordinates in each of the intervals;
replacing keywords of the grid unit serial numbers in a finite element model INP file to establish a grid unit set of the finite element model corresponding to each of the intervals and thereby obtain grid unit sets of the finite element model;
using performance parameters of a defect-free composite material as a benchmark, weakening the benchmark according to the intervals of the defect parameter values to obtain weakened benchmarks, and assigning the weakened benchmarks to the grid unit sets of the finite element model respectively, where for each of the grid unit sets of the finite element model, material parameter=benchmark×interval upper limit; and
setting, according to the material parameter of each of the grid unit sets, different material properties and cross-sectional properties for the grid unit sets of the finite element model in an Abaqus/CAE interface to obtain the three-dimensional reconstructed model of the composite material based on the microscopic defects.

The acquiring target defect parameter coordinates and defect parameter values includes: traversing the defect proportion parameter matrix to find non-zero and non-one defect parameters and coordinates, and outputting the target defect parameter coordinates and the defect parameter values through a third function.

The disclosure further proposes a composite material modeling system, including: a CT slice image acquisition module, a defect parameter determination module, a finite element model construction module, and a three-dimensional model reconstruction module.

The CT slice image acquisition module is configured to acquire a CT slice image of a composite material.

The defect parameter determination module is configured to filter, based on grayscale values of the CT slice image, pixels corresponding to defect features from the CT slice image; determine computational units in the CT slice image, and use a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix.

The finite element model construction module is configured to establish a finite element model of the composite material; and perform, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix.

The three-dimensional model reconstruction module is configured to transfer the all element values of the defect proportion parameter matrix to the grid units of the finite element model of the composite material respectively, and obtain a three-dimensional reconstructed model of the composite material.

The composite material modeling method proposed in the disclosure is capable of establishing a finite element model that possesses the same defect distribution features as the actual composite material. The composite material modeling method enhances the accuracy of finite element simulation and results in a reconstructed model with fewer grids and higher computational efficiency.

### EMBODIMENT

In order to verify the feasibility of the method proposed in the disclosure, an embodiment of the disclosure provides a composite material modeling method based on microscopic defects as an example for detailed description.

The composite material modeling method based on the microscopic defects includes the following steps.

Step 1, a CT slice image of a composite material is acquired.

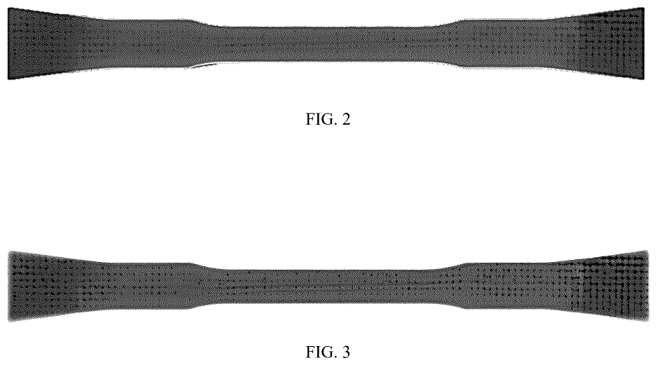

Before imaging, a volatile cleaner is used to clean the composite material to remove surface impurities and improve imaging quality. During imaging, tomographic scanning is performed on the observed object along a thickness direction. The imaging density is uniform and the number of images is reasonable, i.e., multiple CT slice images are obtained to meet actual requirements, so that the CT slice image can clearly show the internal microscopic defects of the composite material, as shown in FIG. 2.

Step 2, the CT slice image of the composite material is preprocessed.

The CT slice image to be processed is stored in the folder where the matrix laboratory (Matlab) program is located, and the image is named in a format “slice image sequence number.tif”.

The function “I=imread (′image name.tif, ‘PixelRegion’, {[650,950], [27,2470]})” is used to read the image, the image file name is input, the ordinate range of the image pixels to be read is set as [650,950], and the abscissa range of the image pixels to be read is set as [27,2470].

The read image is passed to the function “imgGray=rgb2gray(I)” to convert the image to grayscale format, and the grayscale values of the boundary pixels of the composite material and the grayscale values of pixels of the defects and their boundaries are read in the graph interface.

The Laplacian sharpening filter “laplacianFilter=[0 −1 0; −1 4 −1; 0 −1 0]” is defined, the parameters in the filter operator [0 −1 0; −1 4 −1; 0 −1 0] are adjusted to clearly express the image defect features without distortion, as shown in FIG. 3.

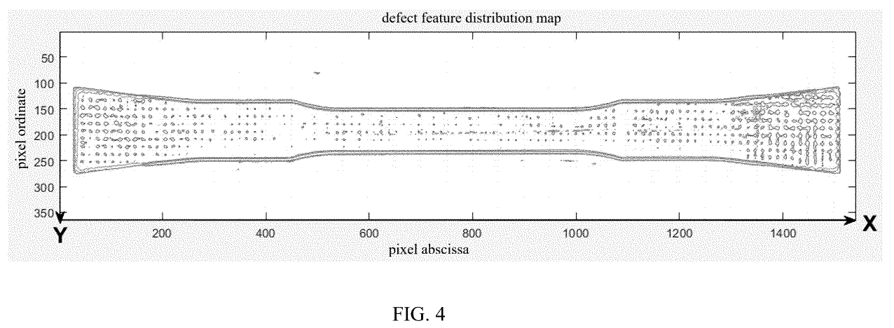

The “imcontour(modifiedImage,4)” function (i.e., the first function) is used to draw pixel grayscale contour lines to obtain a defect feature distribution map of the composite material, as shown in FIG. 4. The defect feature distribution map is compared with the original CT slice image of the composite material, and the parameters of the Laplacian sharpening filter (i.e., the second function) in step 2 are adjusted to improve the identification accuracy.

Step 3, a defect parameter matrix of the CT slice image of the composite material is calculated.

The pixel grayscale values of the CT slice image are taken as the quantification reference, within the composite material pixel region, a loop statement “for i=1:5:size(img, 1)” is used to traverse all grayscale pixels, a 5×5 pixel area is set as a computational unit.

Based on the grayscale values of the pixels of the defects and their boundaries read in Step 2, the grayscale threshold for distinguishing defects is set at 0.41. The function “count=sum(group(:)<=0.41)” is used to filter out the number of pixels with a grayscale value less than the grayscale threshold in each computational unit, and the ratio of the number of grayscale pixels representing the microscopic defects of the composite material to the total number of pixels in the computational unit is calculated.

Within the image reading area, number of computational units=total number of pixels in image reading area/total number of pixels, i.e., 25, in one computational unit. Each computational unit represents an output element, including a defect pixel ratio parameter. The ratio parameters for all computational units included in the CT slice image are calculated, the defect ratio parameter variable set stored in the recognition program is open, and saved as an Excel file to obtain the defect parameter matrix. A part of the parameter matrix is shown in Table 1.

TABLE 1
The part of the parameter matrix of the composite material
modeling method based on the microscopic defects.

| | 13 | 14 | 15 | 16 | 17 | 18 |
|---|---|---|---|---|---|---|
| 34 | 0.2400 | 0.1200 | 0.4000 | 0.2400 | 0.0400 | 0.4800 |
| 35 | 0.3600 | 0.2800 | 0.3200 | 0 | 0 | 0.1600 |
| 36 | 0.9600 | 0.8400 | 1 | 0.9200 | 0.4400 | 0.8400 |
| 37 | 0.2000 | 0.1200 | 0.2400 | 0.2800 | 0.2400 | 0.5600 |
| 38 | 0 | 0.0400 | 0.2000 | 0.1600 | 0.4800 | 0.6400 |
| 39 | 0.8000 | 0.4400 | 0.8400 | 0.9600 | 0.8400 | 0.9600 |
| 40 | 0.2400 | 0.1200 | 0.5200 | 0.1600 | 0.1600 | 0.4000 |
| 41 | 0.1200 | 0.1600 | 0.3600 | 0.0400 | 0.0800 | 0.2800 |
| 42 | 0.5600 | 0.6800 | 1 | 0.8400 | 0.5200 | 1 |
| 43 | 0.1600 | 0.3200 | 0.3200 | 0.4000 | 0.3600 | 0.8800 |
| 44 | 0.0400 | 0.4400 | 0.3200 | 0.2000 | 0.3600 | 0.7600 |
| 45 | 0.7200 | 0.6800 | 0.9200 | 0.8400 | 0.7600 | 0.9200 |
| 46 | 0.0800 | 0.3600 | 0.6000 | 0.2800 | 0.4000 | 0.4800 |
| 47 | 0.0800 | 0.0400 | 0.6000 | 0.0400 | 0.0400 | 0.2800 |

Step 4, based on the Abaqus/CAE finite element software, the finite element model is established.

In the component module of the Abaqus/CAE finite element software, a full-scale geometric model of the composite material is established, as shown in FIG. 5.

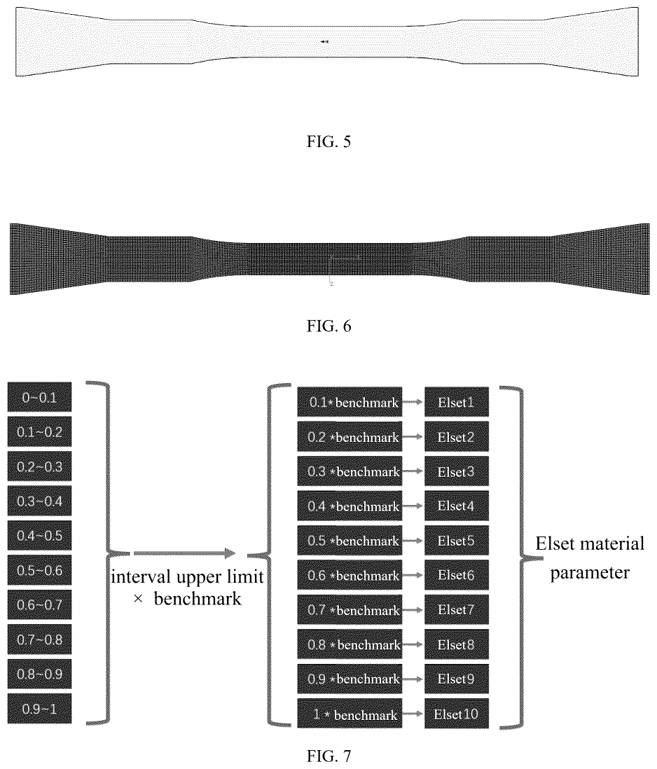

Based on the order of the defect parameter matrix, the grid density of the finite element model is set so that size of the finite element grids is same as the size represented by the elements of the defect parameter matrix. Section properties, assembly attributes, and boundary conditions, etc., are set to obtain the finite element model of the composite material, as shown in FIG. 6.

The .INP file including information about the finite element model of the composite material is exported. The .INP file includes details about the solver, material properties, grid unit attributes, and other information related to the established finite element model. Modifications to the content of keywords in the .INP file can directly accomplish operations such as the establishment of grid unit sets and modification of material properties, facilitating the subsequent model reconstruction.

Step 5, a three-dimensional reconstructed model of the composite material is established based on the microscopic defects.

In Python, a function “inpfile=open (“f:/file_name.inp”,‘r+’)” is used to read the .INP file exported in Step 4; a function “df=pd.read_excel(file_path)” is used to read the Excel file of the defect parameter matrix output in Step 3.

The “for row_index, row in df.iterrows( ):” loop is used to traverse the data in the Excel file to search for defect parameters and coordinates that are neither 0 nor 1, and a function “results.append((row_index, col_index, value))” (i.e., the third function) is used to output the coordinates and values of the target defect parameters.

The defect proportion parameters are divided evenly into 10 intervals according to their sizes: 0-0.1, 0.1-0.2, . . . , 0.9-1. For each interval, the element (finite element grid unit) serial numbers corresponding to the parameter coordinates in the .INP file are filtered, and the Python function “newset1=“**Elset, elset=Set-1, mesh unit number”” is used to replace the keywords and establish the element serial number sets Elset.

Using the material properties of a defect-free material as the benchmark, the benchmark is weakened according to the interval where the defect parameter is located and assigned to the Elset: for Elset corresponding to each interval, the material parameter=benchmark×interval upper limit. The calculation process is shown in FIG. 7. For example, if the benchmark elastic modulus is set to be 200 megapascals (MPa), the element elastic modulus corresponding to the 0-0.1 interval is 200×0.1=20 MPa, and the element elastic modulus corresponding to the 0.1-0.2 interval is 200×0.2=40 MPa. By analogy, different material properties and cross-sectional properties are set for each group of Elset in the Abaqus CAE interface to obtain the three-dimensional reconstructed model of the composite material based on the microscopic defects.

The composite material modeling method proposed in the disclosure involves acquiring the high-resolution CT scan slice image of the composite material and using a Matlab image recognition program to identify and filter out the grayscale pixels corresponding to the defect features. A 5th-order pixel array is employed as the calibration unit, and the ratio of the number of defect pixels in one array to the total number of pixels in the array is calculated as a corresponding element value of the defect parameter matrix. The finite element model of the composite material is established in the Abaqus finite element simulation software, ensuring that the size of finite element grids is same as the size represented by the elements of the defect parameter matrix. The element values of the defect parameter matrix are then transferred to the grid units of the Abaqus finite element model respectively using the Python language, to obtain a three-dimensional reconstructed model of the composite material based on the microscopic defects. The established three-dimensional reconstructed model of the composite material based on the microscopic defects maintains the same defect distribution features as the actual composite material. This method enhances the accuracy of finite element simulation, and the reconstructed model has fewer grid units and higher computational efficiency.

The above description is only an exemplary specific embodiment of the disclosure, but the scope of protection of the disclosure is not limited to this. Those skilled in the art should be included in the scope of protection of the disclosure by equivalent substitution or modification based on the technical solution and inventive concept disclosed in the disclosure.

Furthermore, unless otherwise specified, all technical and scientific terms used in the disclosure have the same meanings as those commonly understood by those skilled in the art to which the disclosure belongs. All references mentioned herein are incorporated by reference for the purpose of disclosing and describing methods related to said references. In case of conflict with any incorporated literature, the content of the specification shall prevail.

What is claimed is:

1. A composite material modeling method, comprising the following steps:
acquiring a computed tomography (CT) slice image of a composite material;
filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
transferring the all element values of the defect proportion parameter matrix to the grid units of the finite element model of the composite material, respectively, and obtaining a three-dimensional reconstructed model of the composite material;
wherein the filtering, based on grayscale values of the CT slice image, pixels corresponding to defect features from the CT slice image; determining computational units in the CT slice image, and using a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix comprises:
acquiring grayscale values of pixels of a boundary of the composite material, defects and boundaries of the defects in the CT slice image;
drawing pixel grayscale contour lines through a first function to obtain a defect feature distribution map of the composite material;
comparing the defect feature distribution map with the CT slice image of the composite material to obtain a comparison result, and adjusting, based on the comparison result, parameters of a second function;
using the grayscale values of pixels in the CT slice image as a quantification reference, to traverse grayscale pixels in the composite material region, and to obtain preset-sized pixel regions as the computational units;
obtaining a grayscale threshold to distinguish the defects, determining a number of pixels with a grayscale less than the grayscale threshold in each of pixel arrays being the preset-sized pixel regions, and determining a ratio of a number of grayscale pixels representing microscopic defects of the composite material in a corresponding one of the computational units to the number of the pixels in the corresponding one of the computational units; and
calculating proportion parameters of the pixel arrays in the CT slice image to output the defect proportion parameter matrix, wherein each of the pixel arrays represents an output element and comprises a defect pixel proportion parameter;
wherein the establishing a finite element model of the composite material; and performing, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix comprises:
determining, according to the defect proportion parameter matrix, an order of the defect proportion parameter matrix, and setting a grid density of the finite element model; and
obtaining the finite element model of the composite material with a same size as the size represented by the elements of the defect proportion parameter matrix, when the grid number of the finite element model is consistent with the number of the computational units in the composite material region of the CT slice image;
wherein the obtaining a three-dimensional reconstructed model of the composite material comprises:
acquiring target defect parameter coordinates and defect parameter values;
dividing the defect parameter values into intervals;
filtering grid unit serial numbers of the finite element model corresponding to defect parameter coordinates in each of the intervals;
replacing keywords of the grid unit serial numbers in a finite element model file to establish a grid unit set of the finite element model corresponding to each of the intervals and thereby obtain grid unit sets of the finite element model;
using performance parameters of a defect-free composite material as a benchmark, weakening the benchmark according to the intervals of the defect parameter values to obtain weakened benchmarks, and assigning the weakened benchmarks to the grid unit sets of the finite element model respectively, wherein for each of the grid unit sets of the finite element model, material parameter=benchmark×interval upper limit; and
setting, according to the material parameter of each of the grid unit sets, different material properties and cross-sectional properties for the grid unit sets of the finite element model in a finite element software interface to obtain the three-dimensional reconstructed model of the composite material based on the microscopic defects;
wherein the acquiring target defect parameter coordinates and defect parameter values comprises: traversing the defect proportion parameter matrix to find non-zero and non-one defect parameters and coordinates, and outputting the target defect parameter coordinates and the defect parameter values through a third function; and
wherein the dividing the defect parameter values into intervals comprises: evenly dividing, according to magnitudes, the defect parameter values into 10 intervals: 0-0.1, 0.1-0.2, . . . , 0.9-1.

2. The composite material modeling method as claimed in claim 1, wherein the finite element model is established based on an Abaqus/computer aided engineering (CAE) finite element software.

3. A composite material modeling system, comprising:
a CT slice image acquisition module, configured to acquire a CT slice image of a composite material;
a defect parameter determination module, configured to filter, based on grayscale values of the CT slice image, pixels corresponding to defect features from the CT slice image;
determine computational units in the CT slice image, and use a ratio of a number of pixels corresponding to the defect features in a corresponding one of the computational units to a number of pixels in the corresponding one of the computational units as a corresponding element value of a defect proportion parameter matrix to thereby obtain all element values of the defect proportion parameter matrix and thus obtain the defect proportion parameter matrix;
a finite element model construction module, configured to establish a finite element model of the composite material; and perform, according to a number of the computational units in the CT slice image, grid division on the finite element model to make a grid number of the finite element model be consistent with the number of the computational units in a composite material region of the CT slice image, and thereby obtain grid units of the finite element model with a same size as a size represented by elements of the defect proportion parameter matrix; and
a three-dimensional model reconstruction module, configured to transfer the all element values of the defect proportion parameter matrix to the grid units of the finite element model of the composite material respectively, and obtain a three-dimensional reconstructed model of the composite material;
wherein the defect parameter determination module is further configured to:
acquire grayscale values of pixels of a boundary of the composite material, defects and boundaries of the defects in the CT slice image;
draw pixel grayscale contour lines through a first function to obtain a defect feature distribution map of the composite material;
compare the defect feature distribution map with the CT slice image of the composite material to obtain a comparison result, and adjust, based on the comparison result, parameters of a second function;
use the grayscale values of pixels in the CT slice image as a quantification reference to traverse grayscale pixels in the composite material region, and to obtain preset-sized pixel regions as the computational units;
obtain a grayscale threshold to distinguish the defects, determine a number of pixels with a grayscale less than the grayscale threshold in each of pixel arrays being the preset-sized pixel regions, and determine a ratio of a number of grayscale pixels representing microscopic defects of the composite material in a corresponding one of the computational units to the number of the pixels in the corresponding one of the computational units; and
calculate proportion parameters of the pixel arrays in the CT slice image to output the defect proportion parameter matrix, wherein each of the pixel arrays represents an output element and comprises a defect pixel proportion parameter;
wherein the finite element model construction module is further configured to determine, according to the defect proportion parameter matrix, an order of the defect proportion parameter matrix, and set a grid density of the finite element model; and obtain the finite element model of the composite material with a same size as the size represented by the elements of the defect proportion parameter matrix, when the grid number of the finite element model is consistent with the number of the computational units in the composite material region of the CT slice image;
wherein the three-dimensional model reconstruction module is further configured to:
acquire target defect parameter coordinates and defect parameter values;
divide the defect parameter values into intervals;
filter grid unit serial numbers of the finite element model corresponding to defect parameter coordinates in each of the intervals;
replace keywords of the grid unit serial numbers in a finite element model file to establish a grid unit set of the finite element model corresponding to each of the intervals and thereby obtain grid unit sets of the finite element model;
use performance parameters of a defect-free composite material as a benchmark, weaken the benchmark according to the intervals of the defect parameter values to obtain weakened benchmarks, and assign the weakened benchmarks to the grid unit sets of the finite element model respectively, wherein for each of the grid unit sets of the finite element model, material parameter=benchmark×interval upper limit; and
set, according to the material parameters of each of the grid unit sets, different material properties and cross-sectional properties for the grid unit sets of the finite element model in a finite element software interface to obtain the three-dimensional reconstructed model of the composite material based on the micro-defects;
wherein the acquire target defect parameter coordinates and defect parameter values comprises: traversing the defect proportion parameter matrix to find non-zero and non-one defect parameters and coordinates, and outputting the target defect parameter coordinates and the defect parameter values through a third function; and
wherein the divide the defect parameter values into intervals comprises: evenly dividing, according to magnitudes, the defect parameter values into 10 intervals: 0-0.1, 0.1-0.2, . . . , 0.9-1.

4. A computer device, comprising: a memory and a processor, wherein the memory stores a computer program, and the computer program is configured to, when executed by the processor, implement the composite material modeling method as claimed in claim 1.

5. A computer-readable storage medium, wherein the computer-readable storage medium is stored with a computer program, and the computer program is configured to, when executed by a processor, implement the composite material modeling method as claimed in claim 1.
